(19) United States
(12) Patent Application Publication
(10) Pub. No.: US 2005/0001908 A1
(43) Pub. Date: Jan. 6, 2005

(54) Digital camera with continual image acquisition

(76) Inventor: Steven K. Lee, Edina, MN (US)

Correspondence Address: BECK AND TYSVER, 2900 THOMAS AVENUE SOUTH, SUITE 100, MINNEAPOLIS, MN, 55416, US

(21) Appl. No.: 10/860,822

(22) Filed: Jun. 4, 2004

Related U.S. Application Data
(60) Provisional application No. 60/476,104, filed on Jun. 5, 2003.

(51) Int. Cl. H04N 5/262

(52) U.S. Cl. 348/231.2

(57) ABSTRACT

A digital camera is presented in which images received on an image sensor are continually stored on a buffer before a button is depressed. Depressing the button causes the images stored immediately prior to pressing the button to be stored. When the buffer is filled, new images replace the oldest image on the buffer. If only a portion of the buffer is used at any one time, new images can immediately be acquired after pressing the button.

### CLAIM TO PRIORITY

This application claims priority to U.S. Provisional Patent Application Ser. No. 60/476,104, filed on Jun. 5, 2003.

### TECHNICAL FIELD

The present invention relates to a digital camera having the ability to continually acquire images, where such image acquisition is suspended upon the pressing of a shutter release button.

### BACKGROUND OF THE INVENTION

Digital cameras have become extremely popular in recent years due to the ability to record and review photographs instantaneously without the time and expense of film developing and enlarging. One of the biggest disadvantages of digital cameras when compared with film cameras is shutter lag, which is defined as the time between the release of the shutter button and the acquisition of an image. Most observers believe that a shutter lag under 20 milliseconds will appear instantaneous to most camera users. In a manually focused film camera, the shutter lag is approximately 10-50 milliseconds. With automated focus film cameras, the average shutter lag is between 100 and 800 milliseconds. The range of shutter lag in digital cameras can be up to 5000 milliseconds (or 5 seconds), with an average shutter lag in the year 2002 of around 900-1000 milliseconds. In fact, only the most expensive digital cameras tend to have a shutter lag under 500 milliseconds. This large shutter lag means that there is a noticeable, sometimes annoying delay between the time the shutter button is released and the picture is recorded. During this time, the subject may move out of position, change facial expression, move out of focus, or otherwise disrupt the image that the user expected.

The shutter lag is caused by various mechanized and computational activities that must take place in the digital camera after the shutter button is release. The greatest contributor to shutter lag is probably the auto focus mechanism employed in most cameras. These mechanisms generally function by analyzing the image recorded by the cameras and then mechanically adjusting the lens elements until the image is in focus. Because this auto-focus procedure is responsible for the majority of the shutter lag, digital camera manufacturers have implemented a procedure of pre-focusing the camera. Pre-focus generally occurs by depressing the shutter release mechanism half way down. This causes the camera to focus the image without taking the picture. When the shutter release is then completely depressed, the camera is able to record the image without having to focus the image. This will reduce the shutter lag significantly, with the average pre-focus shutter lag being approximately 300 milliseconds.

Another technique used in digital cameras to overcome shutter lag is a burst or continuous mode of image acquisition. In this mode, the digital camera acquires images into a buffer as fast as it can until the buffer is full. Generally, a digital camera with burst mode will have buffer that can hold between five and twenty images, at an approximate speed of three frames per second in high end consumer cameras. In burst mode, the operator can begin acquiring images just before a crucial event, thereby helping to ensure that they capture an image of the desired event. Of course, the user must be certain to begin capturing images at the correct time before the desired event takes place. If the user begins too soon, the buffer will fill and the camera will stop taking images before the event occurs. If the user begins too late, the desired event will already have taken place before any images are collected. The margin for error is generally only a few seconds long.

Some digital cameras, such as the FinePix S602 Zoom (Fuji Photo Film U.S.A. Inc., Valhalla, N.Y.) and the Nikon CoolPix 5400 (Nikon, Inc., Melville, N.Y.), have a special burst mode (a “final five” mode) that continuously takes pictures when the shutter button is depressed, and remembers the last five pictures when the shutter button is released. In this way, the user does not have to correctly anticipate when the desired event will take place. As long as they are depressing the shutter button during the desired event, they need only release the shutter soon after the event so as to save the image of the event in the buffer.

Although this mode is a useful improvement in digital cameras, there are still several significant disadvantages. First, the user must select the mode in order to take advantage of it. Because the mode is considered an advanced feature, the typical consumer user will not be aware of or be comfortable with the mode and its use. Second, since the cameras that use the “final five” mode are general auto-focus cameras, the user will expect the camera to handle all required focusing for the image. Unfortunately, in order to avoid the focusing lag, cameras generally turn off the auto-focusing once the shutter button is released and images are being acquired. This means that the user cannot select a subject while the shutter button is depressed and images are being acquired, because the camera will not focus on the selected subject. What is needed is an improved method of avoiding shutter lag and acquiring images in a digital camera that does not have these problems.

### SUMMARY OF THE INVENTION

The present invention meets this need by providing a digital camera capable of continual image acquisition. Unlike the burst mode in prior art cameras, the present invention camera would not wait until a shutter release button is depressed before images are acquired. Rather, the camera would continually record images to a buffer, while always storing a certain number of prior images in the buffer for later retrieval. Upon the shutter release button being depressed, or shortly thereafter, the camera ceases acquiring new images, allowing the user to review, select, or store the images then stored in the buffer into more persistent storage.

### BRIEF DESCRIPTION OF THE DRAWINGS

FIG. 1 is a block diagram of the digital camera components central to the present invention.

FIG. 2 is a block diagram showing a buffer memory containing a plurality of images.

FIG. 3 is a flow chart showing the method used in the present invention.

### DETAILED DESCRIPTION OF THE INVENTION

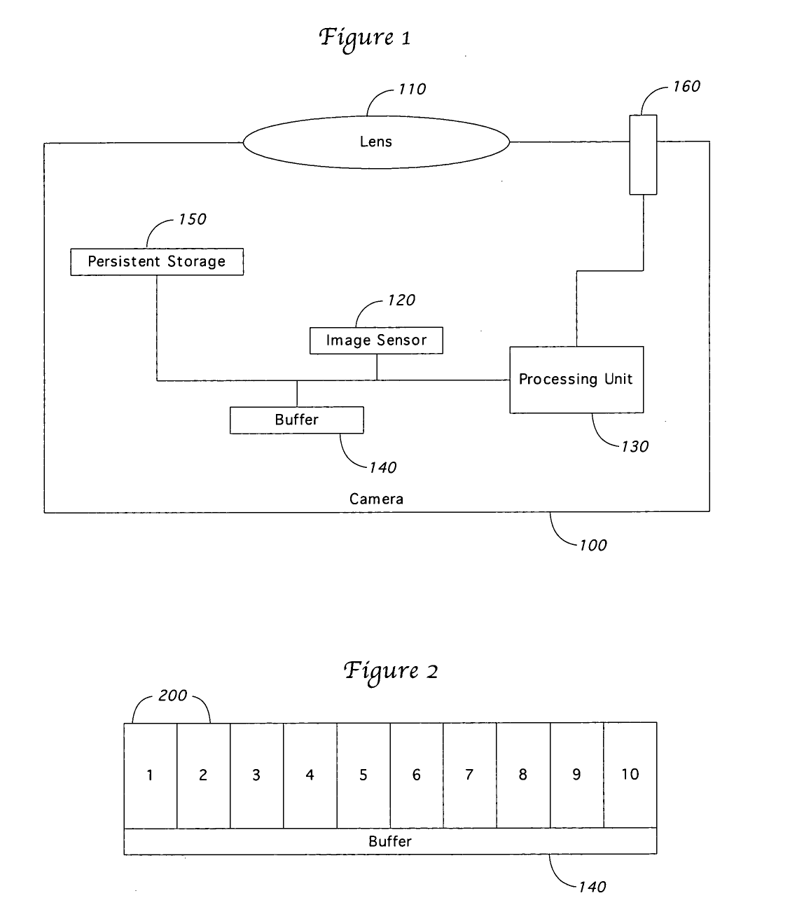

A digital camera 100 of the present invention is shown in FIG. 1. The light for an image is acquired through lens 110, which focuses the light on an image sensor 120. The image sensor can be a CCD sensor, a CMOS sensor, or an X3 image sensor from Foveon, Inc. (Santa Clara, Calif.). X3 is a registered U.S. trademark of Foveon, Inc. The X3 image sensor uses three separate layers of pixel sensors embedded in silicon, as opposed to the traditional CCD and CMOS sensors that use a single layer of pixel sensors in a tiled mosaic pattern. The use of the mosaic pattern means that some pixels receive red light, some green light, and some blue light, but no pixel can measure more than one color. Well-known mathematical interpolation techniques are used to determine a value for all three colors at a given pixel. Since the X3 sensor captures red, green, and blue light at every pixel, there is no need for complex interpolation to estimate the color levels at pixels that lack a sensor for a particular color.

This interpretation is part of the image processing that is done by processing unit 130 after the image is received on image sensor 120. After the processing is completed, the image is stored temporarily in buffer memory 140, and the image sensor 120 is free to receive another image. As in prior art digital cameras, the buffer memory 140 is used only for temporary storage of the images received on the image sensor 120. For more permanent storage, the images are generally transferred from the buffer 140 to persistent storage 150, which may take the form of Compact Flash cards, Smart Media cards, Memory Sticks, Multi Media cards, and Micro Drives from IBM (Armonk, N.Y.). Generally, the transfer of the image from the buffer 140 to the persistent storage 150 takes significantly longer than the transfer from the image sensor 120 to the buffer 140. Hence, the use of the buffer 140 allows the image sensor 120 to be ready to acquire an image faster than if the image were transferred directly from sensor 120 to persistent storage 150.

In prior art cameras, the image is acquired on the image sensor 120 whenever a shutter release button 160 is depressed by a user. The user presses the button 160 for every picture that is desired. Alternatively, the user places the camera 100 in burst mode and depresses the shutter release button 160 for a period of time, during which the camera is acquiring images in the buffer 140 as fast as possible, likely on the order of several images per second. The camera 100 can acquire those images until the buffer 140 is full. In some prior art cameras, image acquisition during burst mode ceases once the buffer is filled, even if the user continues to depress button 160. In other prior art cameras, images are recorded through the whole duration of time that button 160 is depressed. If the buffer 140 becomes full, new images are simply recorded over the oldest images.

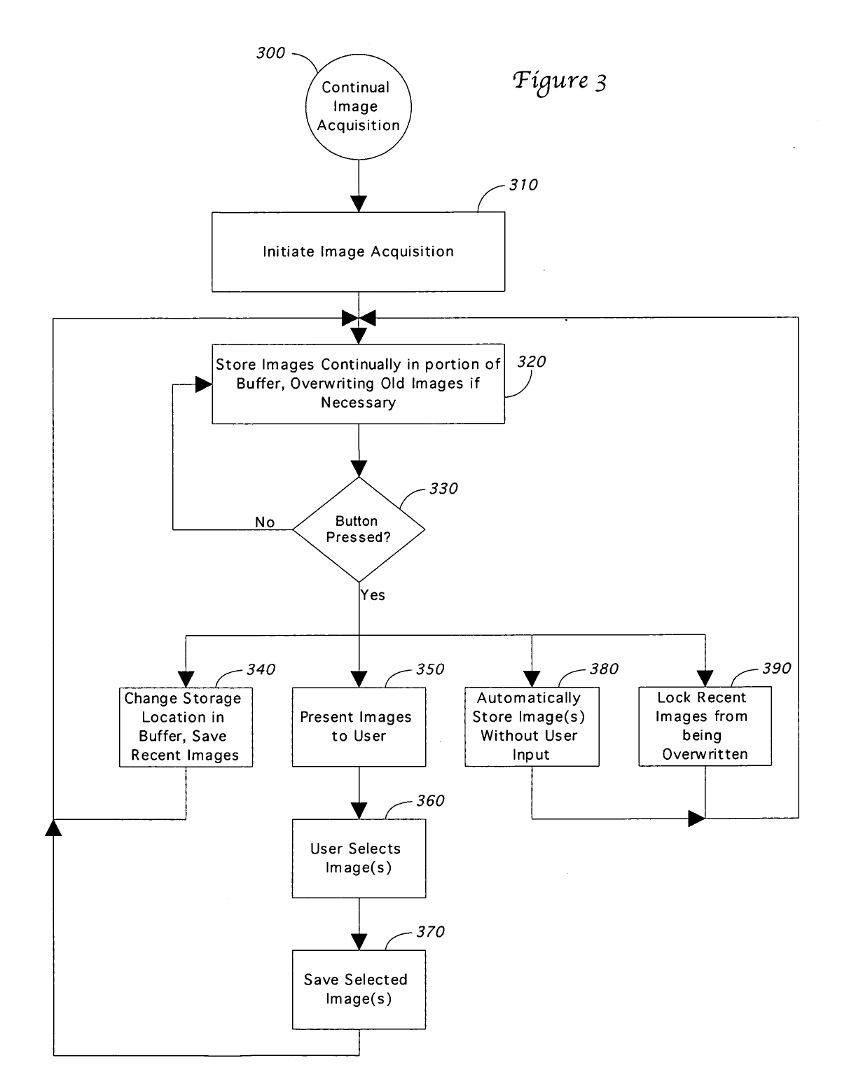

The number of images that can be stored on the buffer 140 varies according to the size of the buffer 140 and the image quality (pixel size and color depth) selected by the user. FIG. 2 shows an example buffer 140, which is divided into ten equal parts representing ten images 200 that can be recorded on the buffer.

The present invention operates in a continual image acquisition mode, where images are constantly being acquired in the image sensor 120 and being recorded to the buffer 140. When the buffer 140 is filled, the oldest image in the buffer is simply overwritten with the new images. Unlike prior art cameras, this occurs when the shutter release button 160 is not depressed by the user. Instead, when button 160 is depressed, the processing unit 130 suspends the acquisition of images at sensor 120 and the related storing of images in the buffer 140. In one embodiment, no more images are transferred to the buffer once the processing unit 130 detects that the shutter release button 160 is depressed. Alternatively, the current image being processed in image sensor 120 could be completed and stored in buffer 140. It could even be advantageous to continue to take several additional images after the shutter release button 160 is depressed. Regardless, immediately upon depression of the shutter release button 160, the buffer 140 will contain multiple images recorded just before the button 160 is depressed, and perhaps several images that occurred after the button 160 is depressed.

At this point, the user can be given the ability to select the desired image and store that image 200 in persistent storage 150. Alternatively, one of the images 200 in the buffer 140 could be automatically selected. In one embodiment, the image closest in time to the pressing of button 160 is selected. In another embodiment, the typical delay that a user encounters between selecting the image in a viewfinder and pressing the button 160 is calculated. This time delay is then used to select an image 200 made a predetermined time before the button 160 is depressed. For instance, if the typical user usually takes 0.3 seconds to press the button 160 after seeing a desired scene, the image 200 stored in the buffer 140 closest in time to 0.3 seconds before the button 160 was pressed would be automatically selected. The time interval could be predetermined by the manufacturer, or could be settable by the processing unit 130 through user input.

The chosen or selected image 200 must be moved from the volatile buffer memory 140 to persistent storage 150 to ensure against the loss of an image 200 in a power loss, such as that caused by a drained battery. This is usually done when the user selects an image 200. This can also be done without user input if the automatic selection of an image 200 is implemented. For instance, the camera 100 could be programmed to store a selected image (or images) 200 in the buffer 140 in the persistent storage 150 whenever a user depresses the shutter release button 160. One of the benefits of this technique is that the buffer 140 is immediately able to receive new images 200 under the continual image acquisition technique of the present invention. If a particular image 200 in the buffer 140 is being saved to persistent storage 150, that spot in the buffer 140 would not be made available for new images until that saving process is completed.

Given the importance of the buffer memory 140 in the present invention, the size and speed of the buffer 140 will have a significant impact on the performance of the camera 100. As buffers 140 become larger, and the interface between persistent storage 150 and buffer memory 140 becomes faster, it may be possible to transfer a large number of temporary images 200 from the buffer 140 to the persistent storage 150. As an example, the buffer 140 could be designed to store thirty megabytes of images 200. When the button 160 is depressed, or even before this time, all thirty-megabytes could be transferred or “dumped” to a temporary image storage portion of the persistent storage 150. This would completely empty the real buffer 140 without the loss of any images 200. The user could then go back to the images 200 found in the temporary storage portion of the persistent storage 150 at a later time to chose one or more desired images 200. These images 200 would then be moved out of the temporary portion of persistent storage 150 and into a normal, more permanent portion of storage 150. The images 200 that were not selected by the user could then be overwritten by additional images 200 being dumped from the buffer memory 140.

In yet another embodiment, only a portion of available buffer memory 140 is ever used during a continual image acquisition. When the button 160 is pressed, the camera 100 merely starts saving new images 200 at a different portion of buffer memory 140. This allows the images associated with the last button press to remain in the buffer 140 for later handling, and further allows the camera 100 to be immediately available to the user to take additional pictures. Assuming that ten slots are available for images 200 in buffer 140, the camera 100 might use only two images slots during the continual image acquisition process. This means that when the button 160 is pressed, only two images 200 will be stored in connection with a button press. Although this is much fewer that the ten possible images 200 that would be available if all slots in the buffer 140 were used, it does mean that the camera 100 is immediately able to store images for four additional button presses. If the images 200 associated with a button press were immediately dumped to persistent storage 150, the camera 100 could easily be constructed so as to never run out of buffer memory 140. With a larger sized buffer 140, more images could be stored in each portion. It would also be possible to use multiple, physical buffers 140, with each buffer 140 being devoted to a separate push of button 160.

In order to ensure proper focusing of the lens 110 on the image subject, the present invention must allow focusing during this continual image acquisition. While this could occur using standard auto-focus technology, the requirement for mechanized movement of lens elements to focus the lens means that constant auto-focusing would be a tremendous drain on battery power in the camera 140. The present invention therefore is preferably implemented using manual, mechanical focusing by the user, or in a fixed focus camera. As is well known in the prior art, the present invention could use small apertures common on small focal length digital cameras to increase the camera's depth of field and to ease the user's task of manually focusing the camera.

Other ways to conserve battery life must also be considered in the present invention camera to allow the continual acquisition of images in the buffer without excessive battery drain. For instance, a manual zoom ring on lens 110 is utilized on the preferred embodiment of camera 100 rather than the motorized zoom that is common on other optical zoom digital cameras. Alternatively, the optical zoom could be eliminated through the use of a digital zoom, as is well known in the prior art.

The preferred embodiment also saves battery power by utilizing an X3 image sensor. Since the X3 sensor requires no interpolation, it utilizes less power. The X3 sensor also eliminates the need to blur an image to remove interpolation artifacts, thereby allowing greater sharpness in the image with the same size image sensor 120, or similar sharpness with a smaller sensor 120 (and hence reduces the power consumption of the sensor 120).

The method 300 of the present invention is set forth in FIG. 3. The method 300 begins at step 310 with the user initiating continual image acquisition, such as by pressing a power button on the camera 100. Alternatively, a separate process might be used to start continual image acquisition. Once turned on in step 310, the camera 100 continually stores images 200 in a buffer memory 140 in step 320. When the buffer 140 becomes full, the oldest image 200 in a buffer 140 can be overwritten. Step 330 simply checks to see if the user has pressed the button 160. If not, the method 300 stays at step 320 continually saving images 200 to the buffer 140.

If step 330 determines that the button 160 has been pressed, the image acquisition of step 320 no longer takes place in the same way. Instead, one or more selected images 200 created in step 320 must be saved, locked, or presented to the user for selection. In all cases, these images 200 can include images 200 that were received by the image sensor 120 before, during, or immediately after the button 160 is pressed.

The process by which this is done differs depending on either the construction of the camera 100 or the preferences selected by the user. These different possibilities are reflected in flow chart 300 by the split that occurs after step 330.

Step 340 reflects the situation where only a portion of the buffer memory 140 was used to store images in step 320. Step 340 simply moves causes the images 200 stored by step 320 to move to a different area of the buffer 140 (or to a different physical buffer 140). Additional images can then automatically be taken at step 320, again waiting for the user to press button 160. Step 340 may also initiate a process to move the just taken images 200 in the buffer 140 to persistent storage 150.

Step 350 presents the multiple images 200 stored on the buffer 140 to the user. This is preferably accomplished through a user interface on the display screen found on all modern digital cameras. The user then selects one or more images 200 at step 360. These images are stored in persistent storage 150 in step 370. At this point, the continual image acquisition of step 320 can restart, simply writing over the images 200 previously stored in the buffer 140.

Step 380 causes the automatic storage of one or more images 200 after step 330 determines the button 160 has been pressed. As explained above, this could be the image 200 that was being received when the button was depressed, or an image 200 taken a preset time period before the button was depressed. Any image or images 200 in the buffer 140 could be saved in this step 380. The method 300 would then return immediately to step 320 for more image acquisition. The camera 100 could be constructed so that no images 200 are stored at step 320 until after the predetermined images 200 are transferred to persistent storage 150 in step 380. Alternatively, image acquisition at step 320 could begin immediately, with the particular locations of buffer memory 140 containing the images 200 to be saved being unavailable to step 320 until the images 200 are saved to storage 150.

Finally, step 390 relates to a camera 100 designed to continually save images 200 from buffer memory 140 to persistent storage 150. Alternatively, the camera 100 could be designed with an extremely large buffer memory 140, where there is no need to limit the number of images 200 stored with each button press, nor is there a reason to immediately remove the images 200 from the buffer 140. Rather, step 390 simply locks a certain number of image locations in the buffer to prevent step 320 from overwriting the images taken immediately surrounding the press of button 160. For instance, step 390 might protect all images taken three seconds before the user pressed button 160. While step 390 locks these locations, step 320 continues saving images 200 to different locations in buffer 140. These locations would be unlocked only after the user reviews and selects the images at a later time.

Many possible combinations of features and elements are possible within the scope of the present invention. For instance, although the above description was made in the context of a digital still camera, the same idea of continual image acquisition could be utilized in digital motion picture cameras. Consequently, the scope of the present invention is not to be limited to the above description, but rather is to be limited only by the following claims.

1. A method for storing images taken on a digital camera comprising:
a) continually storing images in a buffer memory portion, overwriting the oldest image in the buffer memory portion when the buffer memory portion is full;
b) monitoring a user input for an indication of a desire to save the current image;
c) upon receiving an indication to save the current image, stopping the process of overwriting the oldest images in the buffer memory portion;
d) selecting a subset of the images in buffer memory portion;
e) storing the selected subset in persistent storage within the camera; and
f) returning automatically to step a) after the selected subset is stored in persistent storage.

2. The method of claim 1, wherein the buffer memory is a physical memory having a single portion.

3. The method of claim 1, wherein the buffer memory contains a plurality of portions.

4. The method of claim 1, wherein images are continually stored in that part of the buffer memory portion that does not contain the selected subset of images while the selected subset of images are stored in persistent storage.

5. The method of claim 1, wherein the subset of images in buffer memory is selected without user interaction.

6. The method of claim 5, wherein the subset of images is a single image that was being received when the indication to save the current image was received.

7. The method of claim 5, wherein the subset of images is a single image that was being received a predetermined time period before the indication to save the current image was received.

8. The method of claim 1, wherein the subset of images in buffer memory is selected through a user interface allowing a user to select from all the images in the buffer memory portion.

9. A method for storing images taken on a digital camera comprising:
a) continually storing images in a first buffer memory, overwriting the oldest image in the first buffer memory when the first buffer memory is full;
b) monitoring a user input for an indication of a desire to save an image;
c) upon receiving an indication to save the current image, continually storing images in a second buffer memory, overwriting the oldest image in the second buffer memory when the second buffer memory is full.

10. The method of claim 9, wherein the user input is a shutter release button.

11. The method of claim 9, wherein the first buffer memory and the second buffer memory exist within the same physical memory.

12. A method for storing images taken on a digital camera comprising:
a) continually storing images in a buffer memory, overwriting the oldest image in the buffer memory when the buffer memory is full;
b) monitoring a user input for an indication of a desire to save the current image;
c) upon receiving an indication to save the current image, selecting a single image found in the buffer memory without additional user interaction and storing the selected image in persistent storage within the camera; and
d) returning to step a) thereby automatically overwriting all images in the buffer memory.

13. The method of claim 12, wherein the selected image is that image that was being received when the indication to save the current image was received.

14. The method of claim 12, wherein the selected image is that image that was being received a predetermined time period before the indication to save the current image was received.

15. A digital camera comprising:
a) a lens;
b) an image sensor that receives an image based upon light passing through the lens;
c) a button;
d) a non-volatile persistent storage;
e) a buffer for continually recording images before the button is depressed; and
f) a processing unit that, upon the pressing of the button, causes an image that was acquired by the image sensor before the pressing of the button to be copied from the buffer to the persistent storage.

16. The camera of claim 15, further comprising a manual focus adjustment.

17. The camera of claim 16, wherein the image sensor is an X3 image sensor.

18. A digital camera comprising:
a) a lens;
b) an image sensor that receives an image based upon light passing through the lens;
c) a button;
d) a memory buffer;
e) a persistent storage;
f) means for continually recording images in a buffer prior to the pressing of the button; and
g) means for selecting images in the buffer to be stored in the persistent storage.
